(19) United States
(12) Patent Application Publication
(10) Pub. No.: US 2021/0406832 A1
(43) Pub. Date: Dec. 30, 2021

(54) TRAINING A MACHINE LEARNING ALGORITHM TO PREDICT BOTTLENECKS ASSOCIATED WITH RESOLVING A CUSTOMER ISSUE

(71) Applicant: Dell Products L. P., Round Rock, TX (US)

(72) Inventors: Tejas Naren Tennur Narayanan, Austin, TX (US); Gautam Kaura, Austin, TX (US); Sumit Wadhwa, Austin, TX (US); Raghav Sarathy, Austin, TX (US); Anita Ako, Austin, TX (US); Amit Sawhney, Round Rock, TX (US); Konark Paul, Bangalore (IN); Jeannie Fitzgerald, Ennis (IE); Rohitt R. Punjj, Ludhiana (IN); Karthik Ranganathan, Round Rock, TX (US); Sekar Palanisamy, Austin, TX (US)

(21) Appl. No.: 16/916,996

(22) Filed: Jun. 30, 2020

(51) Int. Cl. G06Q 10/10; G06Q 10/06; G06Q 10/00; G06Q 10/08; G06Q 30/00; G06F 11/30; G06F 11/34; G06N 20/00; G06N 5/04; G06F 16/29

(52) U.S. Cl. CPC G06Q 10/103; G06Q 10/06316; G06Q 10/20; G06Q 10/083; G06Q 30/016; G06Q 10/063118; G06Q 10/0875; G06Q 30/012; G06F 11/302; G06F 11/3476; G06N 20/00; G06N 5/04; G06F 16/29; G06Q 10/0633

(57) ABSTRACT

In some examples, a server may receive a user communication describing an issue with a computing device and assign a case to the computing device. The server may determine previously provided telemetry data (e.g., logs and usage data sent by the computing device) as well as previous cases associated with the computing device. Machine learning may be used to predict, based on the user communication, the telemetry data, and the previous cases, a predicted cause of the issue, a predicted time to close the case, and a predicted set of steps to resolve the issue. The machine learning may predict a bottleneck in at least one step of the set of steps that causes the predicted time to close to exceed a threshold and predict one or more actions to address the bottleneck. The server may automatically perform at least one action of the one or more actions.

### BACKGROUND OF THE INVENTION

### Field of the Invention

This invention relates generally to computing devices and, more particularly to a server to predict bottlenecks to resolving a customer issue and to recommend one or more next actions to perform to address the bottlenecks.

### Description of the Related Art

As the value and use of information continues to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a computer manufacturer (e.g., Dell®) sells a hardware product (e.g., computing device), the product may come with a warranty. For example, the manufacturer may warranty that the product will be free from defects in materials and workmanship for a specified period of time (e.g., 2 years), starting from the date of invoice. In addition, the manufacturer may offer, for an additional fee, additional services, such as, for example, Accidental Damage Service, Hardware Service Agreement (e.g., remote diagnosis of issues, pay only for parts if product is serviced, exchange for same or better product if product cannot be fixed), Premium Support services, and the like.

When a user of the computing device encounters an issue (e.g., hardware issue, software issue, or both), then the user may initiate (e.g., via email, chat, or a call) a service request to technical support associated with the manufacturer. The user may be arbitrarily assigned (e.g., without regard to the type of problem, the device platform, previous service requests associated with the computing device, and the like) to an available support technician. The resolution of the issue may depend primarily on the skill of the assigned support technician, such that a particular support technician may resolve a same issue faster than a less experienced support technician but slower than a more experienced support technician.

The time to resolve an issue is a major factor in customer satisfaction and may influence the user's decision to acquire (e.g., buy or lease) other products in the future from the manufacturer of the computing device, and may influence others (e.g., the user's posts regarding the user's experience on social media), and the like. Thus, resolving an issue in a timely fashion may result in increased customer satisfaction and additional revenue generated as a result of future acquisitions by the user and by others. Conversely, not resolving the issue in a timely fashion may result in customer dissatisfaction and loss of future revenue by the user and by others (e.g., that are influenced by the user via the user's posts on social media).

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, a server may receive a user communication describing an issue with a computing device and assign a case to the computing device. The server may determine previously provided telemetry data (e.g., logs and usage data sent by the computing device) as well as previous cases associated with the computing device. Machine learning may be used to predict, based on the user communication, the telemetry data, and the previous cases, a predicted cause of the issue, a predicted time to close the case, and a predicted set of steps to resolve the issue. The machine learning may predict a bottleneck in at least one step of the set of steps that causes the predicted time to close to exceed a threshold and predict one or more actions to address the bottleneck. The server may automatically perform at least one action of the one or more actions to address the bottleneck and reduce the predicted time to close the case. In some cases, the machine learning may predict an additional bottleneck in at least one sub-step of one of the steps in the set of steps and predict one or more additional actions to address the additional bottleneck. The server may automatically perform at least one additional action of the one or more additional actions to address the additional bottleneck and reduce the predicted time to close the case.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a computing device initiating a communication session with a server, according to some embodiments.

FIG. 2 is a block diagram of a case that includes steps and predictions associated with the steps, according to some embodiments.

FIG. 3 is a block diagram of timelines associated with a case, including creating and resolving a work order, according to some embodiments.

FIG. 4 is a flowchart of a process that includes using machine learning to predict a bottleneck associated with a step in a process to resolve an issue, according to some embodiments.

FIG. 5 is a flowchart of a process to train a machine learning algorithm, according to some embodiments.

FIG. 6 illustrates an example configuration of a computing device that can be used to implement the systems and techniques described herein.

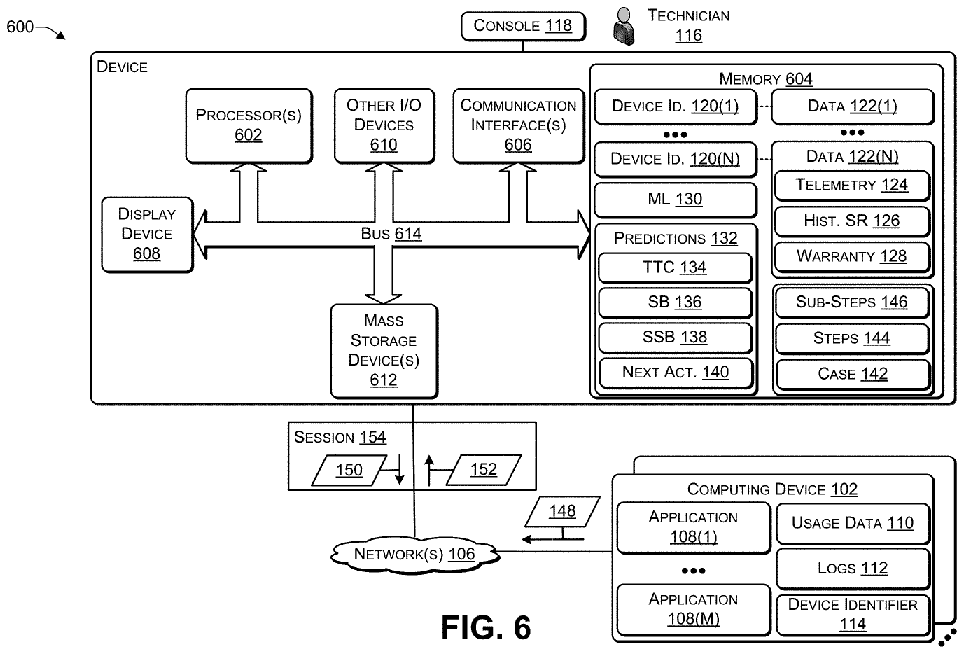

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

A computer manufacturer, such as, for example, Dell®, may provide service technicians to resolve issues related to devices sold by the computer manufacturer. For example, after a user has purchased a computing device, the user may encounter an issue, such as a hardware issue, a software issue, or both. To resolve the issue, the user may contact (e.g., via email, chat, or a call), a technical support department of the manufacturer. The user may be assigned to a support technician who may be tasked with resolving the issue. One or more machine learning algorithms may be used to predict bottlenecks in the issue resolution process.

The computing device may periodically send telemetry data that includes information associated with the computing device, including a current configuration of the hardware and software of the computing device, how the hardware and software the computing device is being used, logs (e.g., installation logs, error logs, restart logs, memory dumps, and the like) generated by the hardware and software of the computing device, and the like. The telemetry data may include a unique identifier that uniquely identifies the computing device from other computing devices, such as a serial number, a service tag, a media access control (MAC) identifier, or the like. When a user contacts technical support, the server may automatically pull up (e.g., using the unique identifier) previously received telemetry data associated with the computing device of the user. In some cases, the server may send a request to the computing device to send current telemetry data to provide current information associated with the hardware configuration, the software configuration, logs, and usage data associated with the computing device. The server may identify (e.g., using the unique identifier) previous service requests associated with the computing device.

After a user initiates contact with technical support, the server may retrieve telemetry data previously received from the computing device and data associated with previous service requests. In some cases, the server may also retrieve telemetry data and service requests associated with similarly configured computing devices. The support technician may communicate with the user and enter data associated with the user's issue into a database. The machine learning algorithm may analyze the entered data, the previously received telemetry data, current telemetry data, data associated with previous service requests, data associated with similarly configured computing devices, or any combination thereof to predict one or more bottlenecks in the steps (and, in some cases, sub-steps) involved in resolving the user's issue. For example, a hardware issue may initially manifest as a software issue. The user may initially contact technical support and have the issue temporarily resolved by the installation of software (e.g., a current software application is uninstalled and then reinstalled, a newer version of the software application is installed, an updated driver is installed, or the like). The machine learning algorithm may, based on similarly configured computing devices and countering the same or similar issue, predict that the computing device has an underlying hardware issue and provide a recommendation to the support technician to run diagnostics and possibly replace a particular hardware component to resolve the issue. Thus, instead of the support technician not realizing that there may be an underlying hardware issue and spending time troubleshooting before determining that there may be an underlying hardware issue, the machine learning algorithm uses historical data associated with the computing device and other similarly configured computing devices to predict the underlying hardware issue and inform the service technician not only about the underlying hardware issue but also, based on historical data associated with other similarly configured computing devices (e.g., computing devices with one or more common hardware components), a predicted solution (e.g., replacing the hardware) to resolving the issue. As another example, the machine learning may predict that the issue may be too complex for the currently assigned technician, given the currently assigned technician's experience level and education (e.g., product specific courses), and recommend that the trouble ticket be re-assigned to a more experienced technician. For example, if the issue is associated with a particular type of computing device, such as a gaming machine (e.g., Dell® Alienware®) or a workstation (e.g., Dell® Precision®), and the currently assigned technician has not yet undergone training associated with troubleshooting a gaming machine or a workstation, then the machine learning algorithm may recommend that the trouble ticket be reassigned to a technician who has undergone training associated with troubleshooting a gaming machine or a workstation.

In some cases, multiple machine learning algorithms may be used, with each machine learning algorithm designed to make predictions for a particular step or sub-step in the issue resolution process that may cause a bottleneck. For example, a first machine learning algorithm may be used for a first step, a second machine learning algorithm may be used for a second step, a third machine learning algorithm may be used for a first sub-step, and so on. The manufacturer may continually refine this process by analyzing the issue resolution process, identifying steps where bottlenecks are frequent, and training a machine learning algorithm to predict the bottlenecks and potential solutions to resolve the bottlenecks. A bottleneck is a particular step in the issue resolution process that may take longer than other steps (or more than an average amount of time for that step) to resolve or that may increase the time to resolve the issue. For example, if a particular step is predicted to take significantly longer (e.g., greater than a threshold amount or a threshold percentage) than other steps in the issue resolution process, then that particular step may be considered a bottleneck. The machine learning algorithms are designed predict bottlenecks and possible solutions to the bottlenecks to reduce a time from (i) when an issue causes a case (e.g., trouble ticket) to be opened to (ii) a time when the case is closed because the issue has been resolved. In this way, user satisfaction may be increased because the issue is resolved quickly. Increased user satisfaction may result in the user purchasing additional products and services from the manufacturer of the computing device and in the user making recommendations, such as via social media, to other users to purchase products and services from the manufacturer.

For example, a server may include one or more processors and one or more non-transitory computer-readable storage media to store instructions executable by the one or more processors to perform various operations. The operations may include receiving a user communication (e.g., a service request) describing an issue associated with a computing device and creating a case associated with the computing device. The operations may include retrieving previously received telemetry data sent by the computing device. For example, the previously received telemetry data may include (i) usage data associated with software installed on the computing device and (ii) logs associated with software installed on the computing device. The operations may include sending, from the server, a request to the computing device to provide current telemetry data, receiving, from the computing device, the current telemetry data, and storing the current telemetry data with the previously received telemetry data. The operations may include retrieving previous cases (e.g., previous service requests) associated with the computing device. The operations may include determining, using a machine learning algorithm, a predicted cause of the issue based at least in part on: the user communication, the previously received telemetry data, and the previous cases. In some cases, the predicted cause of the issue may also be determined based at least in part on additional data associated with similarly configured computing devices, where each of the similarly configured computing devices have either: at least one hardware component or at least one software component in common with the computing device. The operations may include determining, using the machine learning algorithm and based at least in part on the cause of the issue, a predicted time to close the case. The operations may include determining, using the machine learning algorithm and based at least in part on the cause of the issue, a plurality of steps to close the case. For example, the steps may provide a map of the steps that the case takes to be resolved. For example, the plurality of steps may include (1) a troubleshooting step to determine additional information associated with the issue, (2) a create work order step to create a work order associated with the case, (3) a parts execution step, based on the issue, to order one or more parts to be installed in the computing device, and (4) a labor execution step to schedule a repair technician to install the one or more parts. The operations may include determining, using the machine learning algorithm and based at least in part on the plurality of steps, a predicted bottleneck associated with at least one step of the plurality of steps. For example, the predicted bottleneck may cause the predicted time to close the case to exceed a pre-determined time threshold (e.g., an average time to close similar cases). The operations may include determining, using the machine learning algorithm and based at least in part on the predicted bottleneck, one or more next actions to take to address the predicted bottleneck (e.g., to reduce the predicted time to close the case). The operations may include automatically performing, by the server, at least one action of the one or more next actions. For example, if the bottleneck is predicted to be caused by the case being assigned to a technician lacking experience with similar cases, then the case may be automatically re-assigned to a different technician who has more experience. As another example, if the bottleneck is predicted to be that a wrong part may be ordered, the server automatically check an ordered part to determine if the ordered part is the correct part. In some cases, the machine learning algorithm may determine that a particular step of the plurality of steps includes one or more sub-steps. For example, the one or more sub-steps may include at least one of: (i) a part dispatch sub-step to dispatch a hardware component to a user location, (ii) a technician dispatch sub-step to dispatch a service technician to the user location, (iii) an inbound communication sub-step to receive additional user communications, (iv) an outbound communication sub-step to contact a user of the computing device to obtain the additional information, (v) an escalation sub-step to escalate the case from a first level to a second level that is higher than the first level, (vi) a customer response sub-step to wait for a user of the computing device to provide additional information, or (vii) a change in ownership sub-step to change an owner of the case from a first technician to a second technician that is different from the first technician. The machine learning algorithm may, based at least in part on the one or more sub-steps, determine an additional predicted bottleneck associated with a particular sub-step of the one or more sub-steps, where the additional predicted bottleneck causes the predicted time to perform the particular step or the particular sub-step to exceed a second pre-determined time threshold. The operations may include determining, using the machine learning algorithm and based at least in part on the additional predicted bottleneck, one or more additional actions to take to address the additional predicted bottleneck to reduce the predicted time to perform the particular step or the particular sub-step and automatically performing at least one additional action of the one or more additional actions.

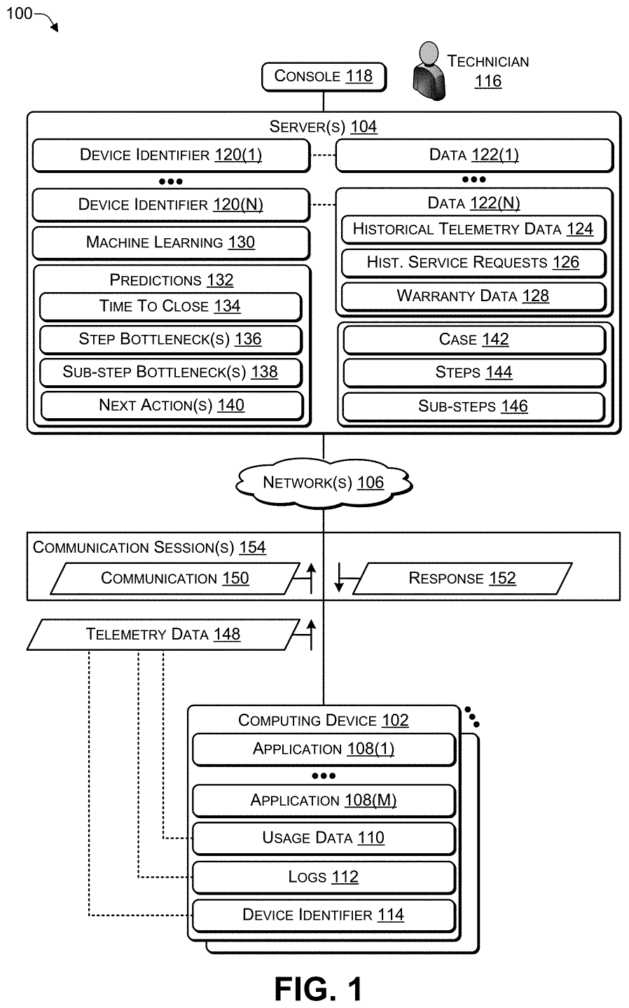

FIG. 1 is a block diagram of a system 100 that includes a computing device initiating a communication session with a server, according to some embodiments. The system 100 may include multiple computing devices, such as a representative computing device 102, coupled to one or more servers 104 via one or more networks 106.

The computing device 102 may be a server, a desktop, a laptop, a tablet, a 2-in-1 device (e.g., a tablet can be detached from a base that includes a keyboard and used independently of the base), a smart phone, or the like. The computing device 102 may include multiple applications, such as a software application 108(1) to a software application 108(M). The software applications 108 may include an operating system, device drivers, as well as software applications, such as, for example a productivity suite, a presentation creation application, a drawing application, a photo editing application, or the like. The computing device 102 may gather usage data 110 associated with a usage of the applications 108, such as, for example, which hardware components each application uses, an amount of time each hardware component is used by each application, an amount of computing resources consumed by each application in a particular period of time, and other usage related information associated with the applications 108. The computing device 102 may gather logs 112 associated with the applications 108, such as installation logs, restart logs, memory dumps as a result of an application crash, error logs, and other information created by the applications 108 when the applications 108 and counter a hardware issue or a software issue. The device identifier 114 may be an identifier that uniquely identifies the computing device 102 from other computing devices. For example, the device identifier 114 may be a serial number, a service tag, a media access control (MAC) address, or another type of unique identifier. The computing device 102 may periodically or in response to a predefined set of events occurring within a predetermined period of time send telemetry data 148 to the server 104, where the telemetry data 148 includes the usage data 110, the logs 112, and the device identifier 114. For example, the predefined set of events occurring within a predetermined period of time may include a number of restarts (e.g., X restarts, where X>0) of an operating system occurring within a predetermined period of time (e.g., Y minutes, where Y>0), a number (e.g., X) of application error logs or restart logs occurring within a predetermined period of time (e.g., Y), or the like.

The server 104 may include one or more servers that execute multiple applications across the multiple servers and behave as a single server. Multiple technicians, such as a representative technician 116, may access the server 104 via one or more consoles, such as a representative console 118.

The server 104 may store the telemetry data 148 in a database in which a device identifier 120 is associated with data 122. For example, a device identifier 120(1) may be associated with data 122(1) and a device identifier 120(N) may be associated with data 122(N). In this example, the device identifier 114 may be one of the device identifiers 120(1) to (N). The data 122 may include historical (e.g., previously received) telemetry data 124, historical (e.g., previously received) service requests 126 (e.g., previous cases associated with the computing device 102), warranty data 128, and other related data.

The server 104 may include one or more machine learning algorithms, such as a representative machine learning 130. The machine learning 130 may include one or more types of supervised learning, such as, for example, Support Vector Machines (SVM), linear regression, logistic regression, naive Bayes, linear discriminant analysis, decision trees, k-nearest neighbor algorithm, Neural Networks such as Multilayer perceptron or similarity learning, or the like.

The machine learning 130 may, based at least in part on the data 122 associated with a particular device identifier 120, make one or more predictions 132, such as a predicted time to close a case (e.g., trouble ticket), predicted step bottlenecks 136, predicted sub-step bottlenecks 138, and one or more next actions 140 associated with each of the step bottlenecks 136 and the sub-step bottlenecks 138. The time to close 134 may be a predicted time to close the case. For example, a relatively simple and straightforward case may have a relatively small time to close while a relatively complex case may have a relatively long time to close. To illustrate, a case that is predicted to be resolved by installing a software upgrade (e.g., operating system upgrade, application upgrade, device driver upgrade or the like) may be predicted to have a relatively short time to close 134. In contrast, a case that is predicted to resolved by replacing one or more hardware components may be predicted to have a relatively longer time to close 134 because the part has to be ordered and either (i) the user may be asked to send the computing device 102 to a repair location or (ii) the manufacturer may send a technician to the user's location to install the part. After predicting a bottleneck at a particular step in the process to resolve an issue, the machine learning 130 may predict one the next actions 140 to take to address the bottleneck. For example, if the issue appears too complex for the assigned technician 116, the machine learning 130 may recommend that the case may be assigned to a different, more experienced technician. As another example, if a replacement part is to be installed and the replacement part is backordered or unavailable for a significant period of time, depending on the warranty (e.g., identified by the warranty data 128), the machine learning 130 may recommend that the user be provided with a new (or refurbished) computing device with equal or better capabilities to replace the computing device 102.

Each case, such as a representative case 142, may include steps 144. One or more of the steps 144 may each include one or more sub-steps 146. The steps 144 and the sub-steps 146 may be part of a process used to resolve and close the case 142.

When a user of the computing device 102 encounters an issue, the user may initiate a communication 150 (e.g., a call, a chat, an email, or the like) with the server 104. In response to receiving the communication 150, the server 104 may assign a technician, such as a technician 116 to respond to the communication 150. The technician 116 may provide a response 150 to thereby initiating a communication session 154 between the user and the technician 116. The technician 116 may ask the user questions (e.g., how often does the issue occur, what operations was the user performing on the computing device when the issue occurred, and the like) and input the user's response as part of the case 142. In some cases, the communication session 154 may include multiple communication sessions. For example, the user may be asked to provide additional information and may do so using more than one communication session. As another example, the technician 116 may, after the initial communication session, gather data regarding resolving the issue and then initiate a second communication session with the user to gather additional data or to install a fix to address the issue.

After the user initiates the communication 150 and the technician 116 is assigned to the user, the technician 116 may open a case, such as the case 142. Depending on the type of case 142, the case 142 may include various steps, such as, for example, ordering a part, installing software, dispatching a technician to the user's location, or the like. In some cases, one or more of the steps 144 may include one or more sub-steps 146. For example, if a hardware component is at fault, the technician 116 may order a new part (e.g., a new component), and after the new part has been received, ask the user to send (or drop off) the computing device 102 to a repair location or send a technician to the user's location to install the new part.

After the case 142 has been created, the machine learning 130 may analyze the data 122 associated with the device identifier 114 of the computing device 102. In some cases, the machine learning 130 may instruct the computing device 102 to send current telemetry data 148 to the server 104. For example, if the machine learning 130 determines that the historical telemetry data 124 is older than a certain period of time (e.g., Z hours or days, Z>0), then the machine learning 130 may instruct the computing device 102 to send the most current telemetry data 148 to the server 104. The machine learning 130 may use the case 142, the telemetry data 148, the historical telemetry data 124, and the historical service requests 126 (e.g., previous cases) to make the predictions 132. For example, the machine learning 130 may analyze the historical service requests 126 and determine that the random-access memory (RAM) of the computing device 102 is intermittently failing which manifests as issues with the applications 108, such as, for example, the applications 108 crashing and/or creating error logs (included in the logs 112). The machine learning 130 may predict that the bottleneck to resolving the case 142 is related to determining whether the RAM is functioning properly. The machine learning 130 may recommend that one of the next actions 140 is to run a full set of diagnostic tests on the RAM. The machine learning may 130 may recommend that one of the next actions 140 is to replace the RAM.

TABLE 1

| Bottleneck | Activity | Definition |
|---|---|---|
| Repeated inbound | Customer initiated | Customer initiates |
| communications | communication | multiple communications |
| Repeated | Technician responds to | Multiple calls made by |
| outbound | customer communication | technician |
| Re-open case | Change case to in- | Further troubleshooting |
| | progress | and/or further dispatch |
| Change owner | Transfer from one | Case has multiple |
| | technician to another | owners, increasing time |
| | technician | to close |
| Repeated | Dispatch parts | More than 1 part |
| dispatches | | dispatched |
| Case title change | Change in case objective | Issue misdiagnosed |
| Collaboration | Internal collaboration | Candidate for escalation |
| | initiated | |
| Logistic issues | Issue dispatching a part | Field rescheduled, |
| | or technician | dispatch rescheduled, |
| | | service interruption, |
| | | attempted delivery, |
| | | parts backlog |
| Work Order | Set parts and/or labor to | Work Order at risk of |
| cancellation | cancelled | being cancelled |

Table 1 illustrates customer service-related bottlenecks, activities associated with each bottleneck, and definitions of each bottleneck. Some of the steps (e.g., states) or sub-steps that contribute to a bottleneck include repeated contact between a user and the technician 116, troubleshooting time exceeds a pre-determined threshold (e.g., A minutes, A>0), number of inbound calls, number of outbound calls, or a combined number of calls exceeds a pre-determined threshold (e.g., B>0), number of ownership changes (e.g., and ownership of the case 142 is transferred from the technician 116 to one or more other technicians), approval for time beyond a predetermined amount of time (e.g., installing a part is predicted to take more than a predetermined amount of time C minutes, C>0), parts backlog, request for approval of parts was rejected, parts were stolen or lost, partial shipment (e.g., some, but not all, parts were shipped at a particular point in time), delivery failed (e.g., no one was available to take delivery of dispatched parts), parts and/or box damaged (e.g., carrier cause damage to the parts and/or box of the parts), wrong/missing address (e.g., building number is correct but suite or apartment number is missing or incorrect), missing parts (e.g., all parts were ordered, but package does not include all the parts that were ordered), technician unavailable (e.g., a technician is unavailable to go to a particular customer location), skill mismatch (e.g., currently assigned technician lacks the skills and/or education to resolve the issue), and the like. A bottleneck is any step or sub-step that is likely to delay resolution of the issue (e.g., closing the case).

Periodically (e.g., at a pre-determined time interval), information about cases that have been closed may be used to retrain the machine learning 130. In this way, the machine learning 130 may be continually retrained to take into account new products made by the manufacturer, new hardware and software components used by the new products, new training provided to the technicians, revisions to the case resolution process (e.g., adding and/or removing steps and sub-steps) to reduce the time to close, and the like.

Thus, when a user encounters an issue with the computing device, the user may contact technical support of a manufacturer of the computing device. The user may be assigned a technician. The technician may open a case (e.g., a trouble ticket). One or more machine learning algorithms may analyze telemetry data received from the computing device, previous service requests, and data provided by the user during the communication with the technician to predict a time to close the case, bottlenecks predicted to occur in one or more steps in the process used to resolve the case, and bottlenecks predicted to occur in one or more sub-steps. The one or more machine learning algorithms may predict one or more next actions to perform to address the step bottlenecks and sub-step bottlenecks.

The machine learning may create a map of the case as the case progresses through the support process, including which steps and sub-steps the case is predicted to pass through. Data, such as recent telemetry data, previously received telemetry data, and a user description of the issue may be used by the machine learning to predict the issue, the likely solution, and a time to resolve the issue and close the case. The machine learning may predict at which step and/or sub-step the issue is likely to get stuck (e.g., stuck means the issue is likely to stay at that step or sub-step for more than a predetermined amount of time) and recommend solutions to address the bottlenecks. In some cases, the machine learning may automatically (e.g., without human interaction) perform one or more of the recommended solutions.

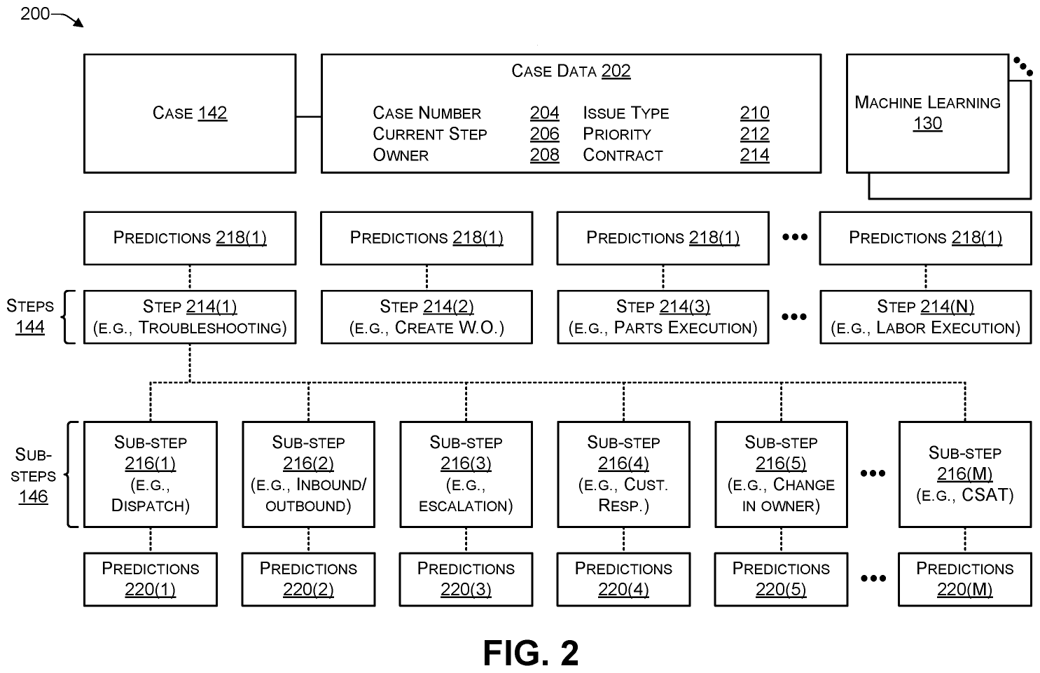

FIG. 2 is a block diagram 200 of a case that includes steps and predictions associated with the steps, according to some embodiments. A case, such as the representative case 142 may have associated case data 202. The case data 202 may include information about the case such as, for example, a case number 204, a current step 206, and owner 208, an issue type CCX, a priority 212, and a contract 214. The case number 204 may be an alphanumeric number assigned to the case 142 to uniquely identify the case 142 from other cases. The current step 206 may indicate at what stage (e.g., a particular step and/or sub-step) the case 142 is in the current process. The owner 208 may indicate a current technician (e.g., the technician 116 of FIG. 1) to which the case 142 is assigned. The issue type 210 may indicate a type of issue determined by the technician based on the initial troubleshooting. For example, the issue type 210 may be software, hardware, firmware, or any combination thereof. The priority 212 may indicate a priority level associated with the case 142. For example, if the user is a consumer that has paid for a higher-level support plan or a higher-level warranty or if the user is part of an enterprise that is one of the top customers (e.g., buying hundreds of thousands of dollars' worth of products and support each year) of the computer manufacturer and has purchased a high level support plan, then the priority 212 may be higher compared to other users. As another example, if the time to resolve the case 142 has exceeded a particular threshold, then the priority 212 may be automatically escalated to a next higher priority level to maintain or increase customer satisfaction. The contract 214 may indicate a current warranty contract between the user and the manufacturer. For example, the contract 214 may indicate that the contract is a standard contract provided to a purchaser of the computing device. As another example, the contract 214 may indicate that the contract is a higher-level warranty (e.g., Support Pro, Silver, or the like) or a highest-level warranty (e.g., Support Pro Plus, Gold, or the like).

The steps 144 may include multiple steps, such as a step 214(1) (e.g., troubleshooting), a step 214(2) (e.g., create a work order (W.O.)), a step 214(3) (e.g., parts execution), to a step 214(N) (e.g., labor execution, N>0). One or more of the steps 214 may include one or more sub-steps. For example, as illustrated in FIG. 2, the step 214(1) may include sub-steps 216(1) (e.g., dispatch part(s)), 216(2) (e.g., receive inbound communication), 216(3) (e.g., escalate to a higher-level technician or to a manager), 216(4) (e.g., customer responsiveness), 216(5) (e.g., change in ownership), to 216(M) (e.g., customer satisfaction, M>0). Of course, other steps of the steps 214 may also include sub-steps.

The machine learning 130 may create predictions 218 corresponding to one or more of the steps 214 and predictions 220 corresponding to one or more of the sub-steps 216. Each of the predictions 218 and 220 may include a time to close the particular step or sub-step, whether the particular step or sub-step is predicted to be a bottleneck, and one or more recommended next actions. For example, when the sub-step 216(1) refers to dispatching a hardware component, the machine learning 130 may predict a bottleneck because the hardware component being ordered may be confused with another hardware component. To illustrate, a malfunctioning keyboard may cause the technician to order a new keyboard to replace the current keyboard. However, there may be many products with similar keyboards and similar part numbers that leads to confusion among the technicians and frequently results in the wrong keyboard being ordered. After the technician troubleshoots the issue and identifies that the keyboard is malfunctioning, based on historical data indicating that the wrong keyboard is frequently ordered, the machine learning 130 may predict that a potential bottleneck may occur in sub-step 216(1) and recommend that the technician double check the keyboard model number prior to ordering a replacement.

As another example, the machine learning 130 may predict that the sub-step 216(2), inbound communications, may be a bottleneck because (1) the user is unable to clearly articulate the issue with the computing device, (2) the user is having problems trying to communicate with the technician due to a poor connection between the user and the technician, or another communication related issue. If the machine learning 130 predicts that the sub-step 216(2) is likely to be a bottleneck, the machine learning 130 may recommend that the technician directly connect to the computing device having the issue and directly diagnose the issue rather than asking the user to perform various tests. Alternately, the machine learning 130 may recommend that the technician ask the user to send or drop off the computing device at a repair location to avoid a protracted set of inbound communications to troubleshoot the issue.

As a further example, the machine learning 130 may predict that the sub-step 216(3) will cause a bottleneck because the issue is likely to be escalated. For example, based on previous calls by the user, the machine learning 130 may predict that the user is likely to be impatient and request escalation if troubleshooting takes more than a predetermined amount of time. As another example, based on previous similar issues handled by the technician, the machine learning 130 may predict that the technician is unsuitable to deal with the issue and the issue is likely to be escalated, either by the user or by the technician. If the machine learning 130 predicts that escalation is likely to be a bottleneck, the machine learning 130 may recommend that the case 140 to be escalated now, rather than waiting for either the user or the technician to escalate the issue at a later time.

As yet another example, if the machine learning 130 predicts that the sub-step 216(4), e.g., the customer's responsiveness, is likely to be a bottleneck, then the machine learning 130 may recommend alternatives to waiting for the customer to respond. For example, based on historical data associated with the user, the machine learning 130 may determine that the user is non-responsive or slow to respond to requests for information (and other requests) from the technician. In such cases, the machine learning 130 may recommend that the technician directly connect to the computing device having the issue and directly diagnose the issue rather than asking the user to provide information. Alternately, the machine learning 130 may recommend that the technician ask the user to send or drop off the computing device at a repair location to avoid waiting for the customer to respond.

As a further example, the machine learning 130 may predict that a bottleneck may occur in sub-step 216(5), e.g., a change in ownership, where the case 142 is transferred from the initially assigned technician to a different technician. For example, the assigned technician may be more skilled in resolving software issues and less skilled in resolving hardware issues. In such cases, the machine learning 130 may predict that the issue is likely caused by a hardware issue and predict that a change in ownership may occur. In such cases, the machine learning 130 may recommend that the case 140 to be re-assigned to a technician who is more skilled in resolving hardware issues to avoid a bottleneck in which a change in ownership occurs at a later time.

As yet another example, the machine learning 130 may predict that sub-step 216(M), e.g., customer satisfaction, may be adversely affected due to the complexity of the issue or an estimated time to close the issue. In such cases, the machine learning 130 may recommend, based on the type of warranty of the computing device, that a new (or refurbished) computing device with equal or better capabilities be provided to the user to replace the current computing device with which the user is having issues. In this way, poor customer satisfaction (CSAT) may be avoided.

Of course, the machine learning 130 may make predictions regarding the steps 214 in addition to the sub-steps 216. For example, the machine learning 130 may predict a bottleneck with step 214(3), e.g., parts execution, because the part ordered to resolve the issue is backordered and currently unavailable. As another example, the machine learning 130 may predict a bottleneck because technicians frequently confuse similar parts and often order the wrong part to resolve the issue associated with the case 142. As yet another example, the machine learning 130 may predict a bottleneck associated with the step 214(N), e.g., labor execution, because a technician is unavailable for a particular period of time to visit the user at the user's location. The machine learning 130 may recommend that the user send in or drop off the computing device to a repair location. The machine learning 130 may recommend that the user be better provided with a new or refurbished computing device with equal or better capabilities.

Thus, after a case has been created by a technician in response to a user contacting support, the machine learning may predict how long it will take to close the case, predict which steps and/or sub-steps bottlenecks may occur, and make recommendations to address (e.g., mitigate) the bottlenecks. By identifying and addressing the bottlenecks identified by the machine learning, the time to close the case may be reduced, thereby improving customer satisfaction.

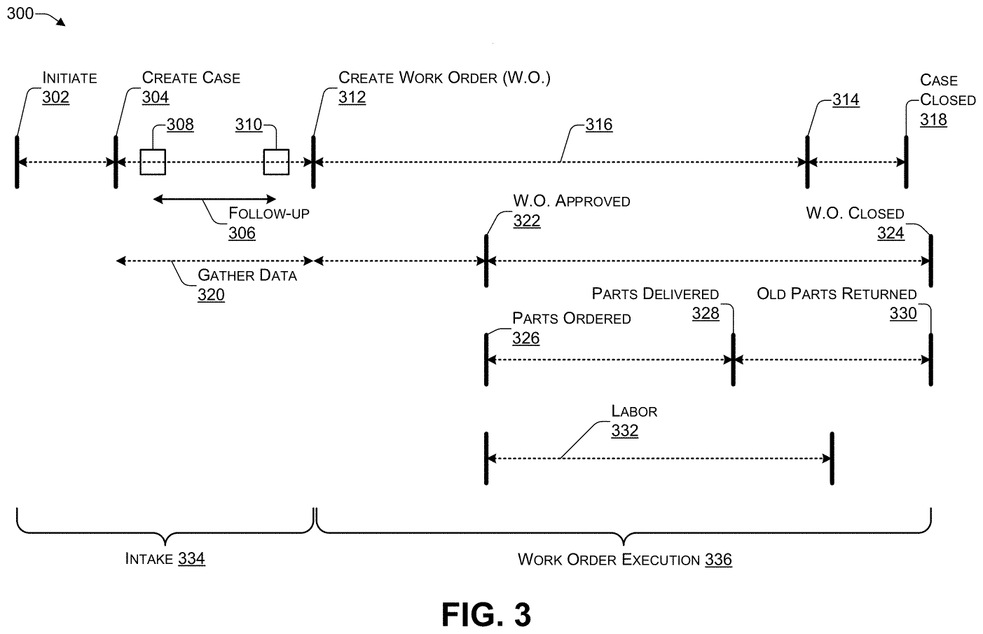

FIG. 3 is a block diagram 300 of timelines associated with a case, including creating and resolving a work order, according to some embodiments. A user may at time 302 initiate contact (e.g., via a call, email, chat, or the like) with support and may be assigned a technician. The technician may create a case at time 304. In some cases, while the technician is troubleshooting the issues, the technician, the user or both may perform one or more follow-up communications 306, such as at a time 308 and a time 310.

At a time 312, the technician may create a work order. The work order may be closed at a time 314. A time period 316 may be a length of time taken to close the work order. The case that was initiated at time 302 may be closed at a time 318.

A time period 320 may be when the technician gathers data, e.g., from the time that the case is created at 304 to the time that the work order is created, at 312. The work order may be approved at a time 322. The work order may be closed at a time 324.

If parts are involved, parts may be ordered at a time 326, e.g., when the work order is approved. The parts may be delivered, at a time 328 and the old parts may be returned, at 330. For example, the old parts may be analyzed to determine a cause of failure. A length of time 332 may identify a time during which a technician may perform labor, such as replacing an old part with a new part.

In this example, from the time 302 that the user initiates communications to the time 312 when the work orders created, is considered an intake time. 334. From the time they work orders created, at 312 two the time that the case is closed, at 318 is considered a work order execution time 336.

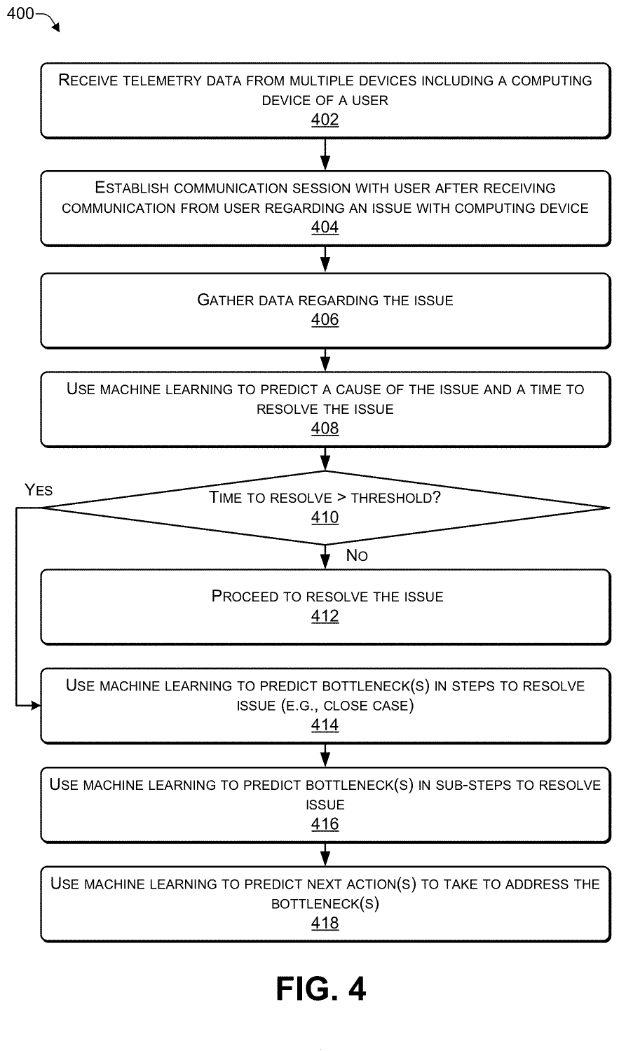

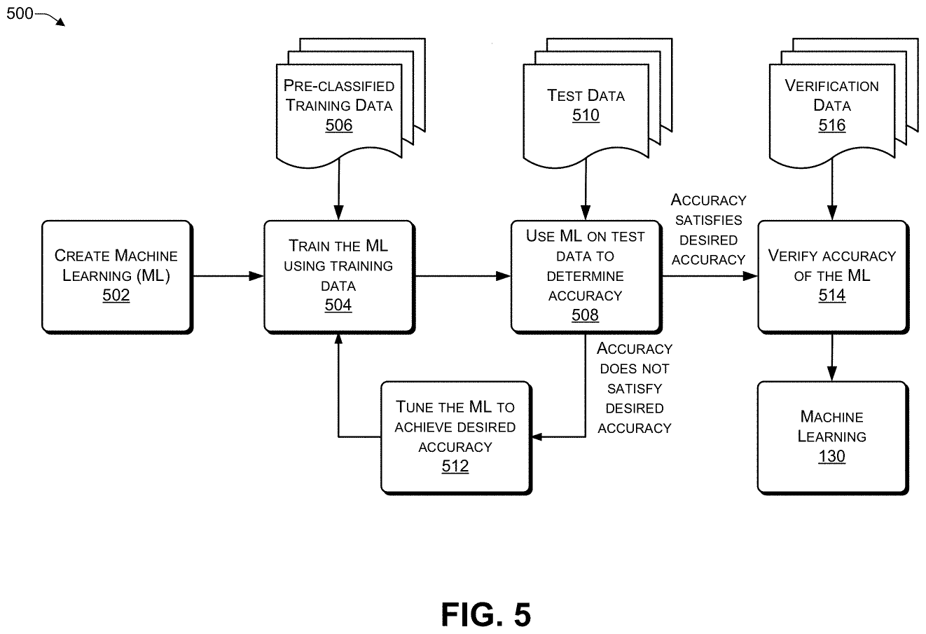

In the flow diagrams of FIGS. 4 and 5, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the 400 and 500 are described with reference to FIGS. 1, 2, and 3 as described above, although other models, frameworks, systems and environments may be used to implement this process.

FIG. 4 is a flowchart of a process 400 that includes using machine learning to predict a bottleneck associated with a step in a process to resolve an issue, according to some embodiments. The process 400 may be performed by the server 104 of FIG. 1.

At 402, the process may receive telemetry data from multiple devices including a computing device of the user. For example, in FIG. 1, the server 104 may receive telemetry data, such as the telemetry data 148, from multiple computing devices, such as the representative computing device 102. The computing device 102 may send the telemetry data 148 to the server 104 (i) periodically (e.g., at a predetermined interval) or (ii) in response to a particular set of events occurring within a predetermined period of time.

At 404, after receiving a communication from a user regarding an issue with a computing device, the process may establish a communication session. For example, in FIG. 1, a user of the computing device 102 may initiate the communication 150, resulting in the server 104 creating the communication session 154 in which the technician 116 is assigned to the user's case.

At 406, data associated with the issue may be gathered. For example, in FIG. 1, the technician 116 may gather data from the customer and retrieve historical telemetry data 124 sent from the computing device 102. In some cases, the server 104 may automatically (e.g., without human interaction) request that the computing device 102 send a latest telemetry data 148.

At 408, one or more machine learning models may be used to predict the cause of the issue and a time to resolve the issue. At 410, the process may determine whether the time to resolve the issue is greater than a predetermined threshold time. If the process determines, at 410, that “no” the time to resolve the issue is less than or equal to the predetermined threshold time, then the process may proceed with a resolution process to resolve the issue. For example, in FIG. 1, the machine learning 130 may be used to predict a cause of an issue associated with the case 142 and to predict a time to address the issue and close the case (e.g., time to close 134). If the predicted time to close 134 is less than or equal to a threshold amount (e.g., average or mean resolution time to resolve a same or similar issues), then the technician 116 may be instructed to follow a standard issue resolution process.

If the process determines, at 410 that “yes” the time to resolve the issue is greater than the predetermined threshold time, then the process may proceed to 414, where machine learning may be used to predict one or more bottlenecks in steps to resolve the issue (e.g., close the case). At 416, machine learning may be used to predict one or more bottlenecks in sub-steps to resolve the issue. At 418, machine learning may be used to predict one or more recommendations, such as one or more next actions to take to address the previously identified bottlenecks. For example, in FIG. 1, if the server 104 determines that the predicted time to close 134 is greater than the predetermined threshold time, then the machine learning 130 may be used to predict the step bottlenecks 136, the sub-step bottlenecks 138, and recommend one or more next actions 140 to address (e.g., mitigate) the bottlenecks 136, 138. In some cases, the server 104 may automatically perform one or more of the next actions 140. For example, the server 104 may automatically escalate a case, automatically transfer a case (e.g., from a first level technician to a more experienced second level technician), automatically order parts (e.g., hardware components), automatically identify an available technician and when the technician is available and initiate a call (or other communication) to automatically schedule the technician (“Press 1 to schedule the technician to replace <part> at <time #1> on <date #1>, Press 2 to schedule the technician to replace <part> at <time #2> on <date #2> . . . ”), and other tasks that the server can automatically perform.

Thus, a server may receive telemetry data from multiple computing devices. When a user of one of the multiple computing devices has an issue with the particular computing device, the user may initiate communications with the server. In response, the server may assign a technician and the technician may establish a communication session with the user. Both the technician and the server may gather data associated with the particular computing device. The server may use machine learning to predict the time to close the case. If the predicted time to close the case is greater than a predetermined threshold amount, then the machine learning may be used to predict bottlenecks in steps in the process to resolve the case and to predict bottlenecks in sub-steps in the process to resolve the case. The machine learning may provide recommendations, such as one or more next actions to take to address the predicted bottlenecks. In this way, the machine learning may be used to reduce the time to close the case, thereby increasing customer satisfaction.

FIG. 5 is a flowchart of a process 500 to train a machine learning algorithm, according to some embodiments. The process 500 may be performed by the server 104 of FIG. 1.

At 502, the machine learning algorithm (e.g., software code) may be created by one or more software designers. At 504, the machine learning algorithm may be trained using pre-classified training data 506. For example, the training data 506 may have been pre-classified by humans, by machine learning, or a combination of both. After the machine learning has been trained using the pre-classified training data 506, the machine learning may be tested, at 508, using test data 510 to determine an accuracy of the machine learning. For example, in the case of a classifier (e.g., support vector machine), the accuracy of the classification may be determined using the test data 510.

If an accuracy of the machine learning does not satisfy a desired accuracy (e.g., 95%, 98%, 99% accurate), at 508, then the machine learning code may be tuned, at 512, to achieve the desired accuracy. For example, at 512, the software designers may modify the machine learning software code to improve the accuracy of the machine learning algorithm. After the machine learning has been tuned, at 512, the machine learning may be retrained, at 504, using the pre-classified training data 506. In this way, 504, 508, 512 may be repeated until the machine learning is able to classify the test data 510 with the desired accuracy.

After determining, at 508, that an accuracy of the machine learning satisfies the desired accuracy, the process may proceed to 514, where verification data for 16 may be used to verify an accuracy of the machine learning. After the accuracy of the machine learning is verified, at 514, the machine learning 130, which has been trained to provide a particular level of accuracy may be used.

The process 500 may be used to train each of multiple machine learning algorithms. For example, in FIG. 1, a first machine learning may be used to determine a first bottleneck at a first step, a second machine learning may be used to determine a second bottleneck at a second step, and so on. Similarly, a third machine learning may be used to determine a third bottleneck at a first sub-step, a fourth machine learning may be used to determine a fourth bottleneck at a second sub-step, and so on.

FIG. 5 illustrates an example configuration of a device 500 that can be used to implement the systems and techniques described herein, such as for example, the computing devices 102 and/or the server 104 of FIG. 1. As an example, the device 500 is illustrated in FIG. 5 as implementing the server 104 of FIG. 1.

The device 500 may include one or more processors 502 (e.g., CPU, GPU, or the like), a memory 504, communication interfaces 506, a display device 508, other input/output (I/O) devices 510 (e.g., keyboard, trackball, and the like), and one or more mass storage devices 512 (e.g., disk drive, solid state disk drive, or the like), configured to communicate with each other, such as via one or more system buses 514 or other suitable connections. While a single system bus 514 is illustrated for ease of understanding, it should be understood that the system buses 514 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 502 are one or more hardware devices that may include a single processing unit or a number of processing units, all of which may include single or multiple computing units or multiple cores. The processors 502 may include a graphics processing unit (GPU) that is integrated into the CPU or the GPU may be a separate processor device from the CPU. The processors 502 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 502 may be configured to fetch and execute computer-readable instructions stored in the memory 504, mass storage devices 512, or other computer-readable media.

Memory 504 and mass storage devices 512 are examples of computer storage media (e.g., memory storage devices) for storing instructions that can be executed by the processors 502 to perform the various functions described herein. For example, memory 504 may include both volatile memory and non-volatile memory (e.g., RAM, ROM, or the like) devices. Further, mass storage devices 512 may include hard disk drives, solid-state drives, removable media, including external and removable drives, memory cards, flash memory, floppy disks, optical disks (e.g., CD, DVD), a storage array, a network attached storage, a storage area network, or the like. Both memory 504 and mass storage devices 512 may be collectively referred to as memory or computer storage media herein and may be any type of non-transitory media capable of storing computer-readable, processor-executable program instructions as computer program code that can be executed by the processors 502 as a particular machine configured for carrying out the operations and functions described in the implementations herein.

The device 500 may include one or more communication interfaces 506 for exchanging data via the network 110. The communication interfaces 506 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 506 can also provide communication with external storage, such as a storage array, network attached storage, storage area network, cloud storage, or the like.

The display device 508 may be used for displaying content (e.g., information and images) to users. Other I/O devices 510 may be devices that receive various inputs from a user and provide various outputs to the user, and may include a keyboard, a touchpad, a mouse, a printer, audio input/output devices, and so forth.

The computer storage media, such as memory 116 and mass storage devices 512, may be used to store software and data. For example, the computer storage media may be used to store the data 122 associated with a corresponding device identifier 120, the machine learning 130, the predictions 132, the case 142, the steps 144, the sub-steps 146, and the like.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer-implemented method comprising:
receiving, by a server, a user communication identifying an issue associated with a computing device;
creating, by the server, a case associated with the computing device;
retrieving, by the server, previously received telemetry data sent by the computing device, the previously received telemetry data comprising usage data and logs associated with software installed on the computing device;
retrieving, by the server, previous cases associated with the computing device;
determining, using a machine learning algorithm executed by the server, a predicted cause of the issue based at least in part on:
the user communication;
the previously received telemetry data; and
the previous cases;
determining, using the machine learning algorithm executed by the server and based at least in part on the cause of the issue, a predicted time to close the case;
determining, using the machine learning algorithm executed by the server and based at least in part on the cause of the issue, a plurality of steps to close the case;
determining, using the machine learning algorithm executed by the server and based at least in part on the plurality of steps, a predicted bottleneck associated with at least one step of the plurality of steps, wherein the predicted bottleneck causes the predicted time to close the case to exceed a pre-determined time threshold;
determining, using the machine learning algorithm executed by the server and based at least in part on the predicted bottleneck, one or more next actions to take to address the predicted bottleneck to reduce the predicted time to close the case; and
automatically performing, by the server, at least one action of the one or more next actions.

2. The computer-implemented method of claim 1, wherein the predicted cause of the issue is further determined based at least in part on:
additional data associated with similarly configured computing devices, wherein each of the similarly configured computing devices have either:
at least one hardware component or
at least one software component in common with the computing device.

3. The computer-implemented method of claim 1, wherein the plurality of steps comprise at least two of:
a troubleshooting step to determine additional information associated with the issue;
a create work order step to create a work order associated with the case;
a parts execution step to order one or more parts to be installed in the computing device; and
a labor execution step to schedule a repair technician to install the one or more parts.

4. The computer-implemented method of claim 1, further comprising:
determining, by the machine learning algorithm, that a particular step of the plurality of steps includes one or more sub-steps.

5. The computer-implemented method of claim 4, wherein the one or more sub-steps comprise at least one of:
a part dispatch sub-step to dispatch a hardware component to a user location;
a technician dispatch sub-step to dispatch a service technician to the user location;
an inbound communication sub-step to receive additional user communications;
an outbound communication sub-step to contact a user of the computing device to obtain the additional information;
an escalation sub-step to escalate the case from a first level to a second level that is higher than the first level;
a customer response sub-step to wait for a user of the computing device to provide additional information; or
a change in ownership sub-step to change an owner of the case from a first technician to a second technician that is different from the first technician.

6. The computer-implemented method of claim 4, further comprising:
determining, using the machine learning algorithm and based at least in part on the one or more sub-steps, an additional predicted bottleneck associated with a particular sub-step of the one or more sub-steps, wherein the additional predicted bottleneck causes the predicted time to perform the particular step or the particular sub-step to exceed a second pre-determined time threshold;
determining, using the machine learning algorithm and based at least in part on the additional predicted bottleneck, one or more additional actions to take to address the additional predicted bottleneck to reduce the predicted time to perform the particular step or the particular sub-step; and
automatically performing, by the server, at least one additional action of the one or more additional actions.

7. The computer-implemented method of claim 1, further comprising:
sending, from the server, a request to the computing device to provide current telemetry data;
receiving, from the computing device, the current telemetry data; and
storing the current telemetry data with the previously received telemetry data.

8. A server comprising:
one or more processors; and
one or more non-transitory computer readable media storing instructions executable by the one or more processors to perform operations comprising:
receiving a user communication identifying an issue associated with a computing device;
creating a case associated with the computing device;
retrieving previously received telemetry data sent by the computing device, the previously received telemetry data comprising usage data and logs associated with software installed on the computing device;
retrieving previous cases associated with the computing device;
determining, using a machine learning algorithm, a predicted cause of the issue based at least in part on:
the user communication;
the previously received telemetry data; and
the previous cases;
determining, using the machine learning algorithm and based at least in part on the cause of the issue, a predicted time to close the case;
determining, using the machine learning algorithm and based at least in part on the cause of the issue, a plurality of steps to close the case;
determining, using the machine learning algorithm and based at least in part on the plurality of steps, a predicted bottleneck associated with at least one step of the plurality of steps, wherein the predicted bottleneck causes the predicted time to close the case to exceed a pre-determined time threshold;
determining, using the machine learning algorithm and based at least in part on the predicted bottleneck, one or more next actions to take to address the predicted bottleneck to reduce the predicted time to close the case; and
automatically performing, by the server, at least one action of the one or more next actions.

9. The server of claim 8, wherein the predicted cause of the issue is further determined based at least in part on:
additional data associated with similarly configured computing devices, wherein each of the similarly configured computing devices have either:
at least one hardware component or
at least one software component in common with the computing device.

10. The server of claim 8, wherein the plurality of steps comprise at least two of:
a troubleshooting step to determine additional information associated with the issue;
a create work order step to create a work order associated with the case;
a parts execution step to order one or more parts to be installed in the computing device; and
a labor execution step to schedule a repair technician to install the one or more parts.

11. The server of claim 8, further comprising:
determining, by the machine learning algorithm, that a particular step of the plurality of steps includes one or more sub-steps.

12. The server of claim 11, wherein the one or more sub-steps comprise at least one of:
a part dispatch sub-step to dispatch a hardware component to a user location;
a technician dispatch sub-step to dispatch a service technician to the user location;
an inbound communication sub-step to receive additional user communications;
an outbound communication sub-step to contact a user of the computing device to obtain the additional information;
an escalation sub-step to escalate the case from a first level to a second level that is higher than the first level;
a customer response sub-step to wait for a user of the computing device to provide additional information; or
a change in ownership sub-step to change an owner of the case from a first technician to a second technician that is different from the first technician.

13. The server of claim 11, further comprising:
determining, using the machine learning algorithm and based at least in part on the one or more sub-steps, an additional predicted bottleneck associated with a particular sub-step of the one or more sub-steps, wherein the additional predicted bottleneck causes the predicted time to perform the particular step or the particular sub-step to exceed a second pre-determined time threshold;
determining, using the machine learning algorithm and based at least in part on the additional predicted bottleneck, one or more additional actions to take to address the additional predicted bottleneck to reduce the predicted time to perform the particular step or the particular sub-step; and
automatically performing, by the server, at least one additional action of the one or more additional actions.

14. One or more non-transitory computer-readable media storing instructions executable by one or more processors to perform operations comprising:
receiving a user communication identifying an issue associated with a computing device;
creating a case associated with the computing device;
retrieving previously received telemetry data sent by the computing device, the previously received telemetry data comprising usage data and logs associated with software installed on the computing device;
retrieving previous cases associated with the computing device;
determining, using a machine learning algorithm, a predicted cause of the issue based at least in part on:
the user communication;
the previously received telemetry data; and
the previous cases;
determining, using the machine learning algorithm and based at least in part on the cause of the issue, a predicted time to close the case;
determining, using the machine learning algorithm and based at least in part on the cause of the issue, a plurality of steps to close the case;
determining, using the machine learning algorithm and based at least in part on the plurality of steps, a predicted bottleneck associated with at least one step of the plurality of steps, wherein the predicted bottleneck causes the predicted time to close the case to exceed a pre-determined time threshold;
determining, using the machine learning algorithm and based at least in part on the predicted bottleneck, one or more next actions to take to address the predicted bottleneck to reduce the predicted time to close the case; and
automatically performing, by the server, at least one action of the one or more next actions.

15. The one or more non-transitory computer readable media of claim 14, wherein the predicted cause of the issue is further determined based at least in part on:
additional data associated with similarly configured computing devices, wherein each of the similarly configured computing devices have either:
at least one hardware component or
at least one software component in common with the computing device.

16. The one or more non-transitory computer readable media of claim 14, wherein the plurality of steps comprise at least two of:
a troubleshooting step to determine additional information associated with the issue;
a create work order step to create a work order associated with the case;
a parts execution step to order one or more parts to be installed in the computing device; and
a labor execution step to schedule a repair technician to install the one or more parts.

17. The one or more non-transitory computer readable media of claim 14, further comprising:
determining, by the machine learning algorithm, that a particular step of the plurality of steps includes one or more sub-steps.

18. The one or more non-transitory computer readable media of claim 17, wherein the one or more sub-steps comprise at least one of:
a part dispatch sub-step to dispatch a hardware component to a user location;
a technician dispatch sub-step to dispatch a service technician to the user location;
an inbound communication sub-step to receive additional user communications;
an outbound communication sub-step to contact a user of the computing device to obtain the additional information;
an escalation sub-step to escalate the case from a first level to a second level that is higher than the first level;
a customer response sub-step to wait for a user of the computing device to provide additional information; or
a change in ownership sub-step to change an owner of the case from a first technician to a second technician that is different from the first technician.

19. The one or more non-transitory computer readable media of claim 17, further comprising:
determining, using the machine learning algorithm and based at least in part on the one or more sub-steps, an additional predicted bottleneck associated with a particular sub-step of the one or more sub-steps, wherein the additional predicted bottleneck causes the predicted time to perform the particular step or the particular sub-step to exceed a second pre-determined time threshold;
determining, using the machine learning algorithm and based at least in part on the additional predicted bottleneck, one or more additional actions to take to address the additional predicted bottleneck to reduce the predicted time to perform the particular step or the particular sub-step; and
automatically performing, by the server, at least one additional action of the one or more additional actions.

20. The one or more non-transitory computer readable media of claim 14, further comprising:
sending, from the server, a request to the computing device to provide current telemetry data;
receiving, from the computing device, the current telemetry data; and
storing the current telemetry data with the previously received telemetry data.
